(19) United States
(12) Patent Application Publication
(10) Pub. No.: US 2007/0251416 A1
(43) Pub. Date: Nov. 1, 2007

(54) Bituminous Mix, Preparation Method and Uses of Said Bituminous Mix

(75) Inventors: Jean-Pierre Dean, Paris (FR); Stephane Jollet, Montigny-Le-Bretonneux (FR)

Correspondence Address: YOUNG & THOMPSON, 745 SOUTH 23RD STREET, 2ND FLOOR, ARLINGTON, VA, 22202, US

(73) Assignee: COLAS, BOULOGNE-BILLANCOURT (FR)

(21) Appl. No.: 11/791,715

(22) PCT Filed: Nov. 29, 2005
(86) PCT No.: PCT/FR05/02965

§ 371 Date: Jun. 26, 2007

(30) Foreign Application Priority Data
Dec. 3, 2004 (FR) 04 12902

(51) Int. Cl. C08L 95/00

(52) U.S. Cl. 106/268; 524/59

(57) ABSTRACT

A coating includes a binder based on natural bitumen or oil industry bitumen. The binder includes, additionally to the base product, a first additive consisting of a hydrocarbon wax which is substantially insoluble at room temperatures in the base bitumen of the binder and whereof the melting point, measured in accordance with the ASTM and D3418 standards, is higher than 85° C. The binder further includes a second additive consisting of a fatty acid ester wax, the wax being of synthetic, plant or fossil plant origin and having a melting point, measured in accordance with the standards, lower than 85° C. The penetration of the base product, measured in accordance with the ASTM D1321 standard, is more than 70 tenths mm and not more than 220 tenths mm.

The present invention relates to a bituminous mix, of the type including:

mineral aggregates containing fines, sand, and optionally chippings; and

a binder based on a base product formed of natural bitumen or of pure or modified oil industry bitumen.

The invention applies to bituminous mixes, made by coating aggregates with the binder.

The mineral aggregates or “charges” used include fines, i.e. particles of sizes smaller than 0.063 mm, natural, artificial or recycled aggregates, i.e. sand, i.e. particles of sizes ranging between 0.063 mm and 2 mm, and optionally chippings, i.e. particles of sizes greater than 2 mm.

A thermomeltable binder of bituminous type for the coating can be natural bitumen or pure or modified oil industry bitumen.

The binder may contain moreover various additives such as polymers and elastomers.

The preparation of a bituminous mix of the type aforementioned involves mixing the binder and the charges at a so-called “production” temperature, then spreading said mixture at an implementation temperature, compacting the spread mixture, and finally cooling the compacted mixture.

Generally, the production temperature ranges between 160° C. and 180° C. according to the compositions. This high temperature exhibits the shortcoming of degrading the binders and of causing the production of fumes containing volatile organic compounds.

To solve this problem, known binders (FR-A-2 721 936) contain a hydrocarbon wax whereof the melting point is greater than 85° C.

By “hydrocarbon wax” is meant low molecular weight saturated polymer hydrocarbons, of characteristic aspect, solid at room temperature, with relatively clear cut melting point and of low viscosity. Their appearance is translucent to opaque but never vitreous. These polymers thus differ in their properties from polymers and elastomers used currently, which exhibit rather wide softening zone and changes gradually from solid state to liquid state when the temperature rises. Moreover, these hydrocarbon waxes are insoluble in bitumen at room temperature.

By “low molecular weight” is meant a molecular weight lower than approx. 6 000 g/mol, and ranging generally between 500 and 6 000 g/mol. Such waxes enable to lower significantly the viscosity of the product when implemented. Thus, the production temperature of the bituminous mix with a binder of the type aforementioned decreases from 30 to 50° C. relative to conventional bituminous mixes.

Moreover, if such hydrocarbon waxes are soluble in bitumen at production temperature, they precipitate nevertheless when cooling and form a fibre network so as to “reinforce” the coating once cast.

Thus, the mixture based on a binder of the type aforementioned exhibits improved mechanical properties, in particular in terms of resistance to static loads and flow behaviour under rising temperature.

However, the binders of the type aforementioned are not quite satisfactory any longer, and in particular, taking the environmental stresses into account, the evolution of the regulations will require significant reduction of the emissions of fumes when preparing or implementing bituminous mixes including hydrocarbon binders.

In the binders described in FR-A 2 721 936, the mass content of hydrocarbon wax in the binder is smaller than 15% of the total mass of the binder. If this content is increased, the production temperature of the coating decreases to a certain extent, but this decrease in temperature is associated with significant degradation of the mechanical properties of the bituminous mix after cooling.

The purpose of the invention is hence to provide a binder enabling to prepare bituminous mixes at lower temperature, while preserving the mechanical properties of the products obtained.

To this end, the invention relates to a bituminous mix of the type aforementioned, characterised in that the binder includes, additionally to said base product, a first additive consisting of a hydrocarbon wax which is substantially insoluble at room temperatures in the base bitumen of the binder and whereof the melting point, measured in accordance with the ASTM D3945 and D3418 standards, is greater than 85° C., and which lowers the production temperature of the bituminous mix relative to that of the base product, in that the binder includes moreover a second additive formed of a fatty acid ester wax, said wax being of synthetic, plant or fossil plant origin and having a melting point, measured in accordance with said standards, lower than 85° C., and in that the penetration of the base product, measured in accordance with the ASTM D1321 standard, is greater than 70 tenths mm and lower than or equal to 220 tenths mm.

By “fatty acid ester” is meant long carbon chain carboxylic organic monoacid esters, in particular with linear carbon chains. The molecules of these ester waxes include a carbon number greater than 20 and preferably greater than 40. These products may be of plant origin, for instance from palm plant oils, of fossil plant origin, such as for instance from lignite fossil waxes or of synthetic origin. These fatty acid ester waxes exhibit a clear cut melting point and have a low viscosity as soon as their melting point has been reached.

Examples of fatty acid esters are montanic acid esters (or octasonoic acid esters), acid of formula C₂₈H₅₆—O₂ or lignoceric acid esters (or tetracosanoic acid esters), acid of formula C24H48—O₂.

According to other features of the bituminous mix according to the invention:

the penetration of the base product, measured in accordance with the ASTM D1321 standard, is greater than 70 tenths mm and lower than or equal to 100 tenths mm, preferably greater than 75 tenths mm and lower than or equal to 100 tenths mm;

the acid index of said fatty acid ester ranges between 10 mg KOH/g and 70 mg KOH/g, in particular ranging between 20 mg KOH/g and 40 mg KOH/g;

said acid index is substantially 28 mg KOH/g;

the molecular weight of said fatty acid ester ranges between 500 g/mol and 3 000 g/mol, in particular ranging between 600 g/mol and 1 000 g/mol;

said molecular weight is substantially 816 g/mol;

the melting point of the hydrocarbon wax ranges between approx. 110° C. and approx. 140° C.;

said hydrocarbon wax is a polymethylene or polyolefine wax, in particular polyethylene, polypropylene or ethylene-propylene copolymer wax;

said hydrocarbon wax has a penetration measured at 25° C. according to the ASTM D1321 standard lower than 15 tenths mm;

the binder contains of the order of 2% to 15% in mass of the assembly formed by the first and second additives with respect to the total mass of the binder;

the binder contains of the order of 0.5% to 10% in mass of the second additive with respect to the total mass of the binder;

the binder contains moreover an elastomer, in particular a styrene-butadiene-styrene copolymer, a styrene-butadiene or a styrene-isoprene-styrene copolymer;

the fatty acid ester is formed by a linear chain carboxylic monoacid ester; and

it includes manufacture-recycled coating aggregates.

By “acid index” is meant the mass in milligrams of potassium hydroxide necessary for neutralising the free fatty acids in one gram of acid ester wax.

The invention also relates to a preparation method of a bituminous mix as defined above, including the following steps:

(a) the binder is mixed with the mineral aggregates,

(b) the mixture obtained from step (a) is spread

(c) the mixture spread is compacted, and

(d) the mixture compacted is left to cool,

characterised in that the steps (a), (b) and (c) are performed at a temperature ranging between 80° C. and 130° C.

At this production temperature, no fumes are visible when implementing the coating. In practice, the emissions of fumes are reduced of the order of a factor 10 with respect to the conventional coatings.

The coating according to the invention shows a good resistance under static and/or dynamic load. It also exhibits good cooling as well as heating behaviour.

In a particular embodiment of the invention, the coating according to the invention includes manufacture-recycled coating aggregates. By “manufacture-recycled coating aggregates” is meant materials as defined in the AFNOR XP P 98-135 standard of December 2001. These aggregates may be hot-mixed with the binder during the preparation method of the bituminous mixes of the type defined above, in replacement of a portion of the mineral charges.

The bituminous mixes according the invention may be used as coatings for carriageway and traffic routes and their appurtenances in road, airport and city areas.

The following example illustrates the invention.

This example concerns a bituminous mix prepared from a binder by the method according to the invention. This mix is subjected, after preparation, to different tests intended for characterising the properties thereof.

Conventional rutting tests according to the NF P 98-253-1 standard are carried out by measuring the rut created by the cyclic passage of a rolling load for a given temperature and a given number of cycles for measuring the resistance of the bituminous mix to permanent deformations.

In the following examples, the percentages stated are weighted percentages relative to the total weight of bituminous mix.

### EXAMPLE 1

In this example, a bituminous mix of BBSG type according to the NFP98-130 standard is prepared. A mix according to the invention which contains a hydrocarbon wax and a montanic acid ester wax accounting for 0.45% of the total weight of the coating is also realised. The base binder used is a bitumen binder of 70/100 type, i.e. its penetration measured according to the ASTM D1321 standard, is strictly greater than 70 tenths mm and smaller than 100 tenths mm.

These coatings are used typically for the realisation of road carriageway surface layers, as well as airport, city carriageway surface layers and their dependences.

The results on Table 1 illustrate the effect of these waxes on the application temperature of the coating and the thermoplastic properties of this mix.

TABLE 1

| | | | | Rut |
|---|---|---|---|---|
| | Bituminous | Hydrocarbon | | 30000 |
| | Binder | Wax + Montanic | Coating | cycles |
| | 70/100 | acid | Temperature | at 60° C. |
| | (%) | ester wax | (° C.) | (%) |
| Conventional | 5.3 | — | 165 | 3.1 |
| mix | | | | |
| Mix | 5.3 | 0.45 | 125 | 3.0 |
| according to | | | | |
| the invention | | | | |

In such a case, the coating which contains according to the invention the mixture of waxes possesses a resistance to permanent deformations identical to that of the conventional coatings, but with a lower coating temperature by 40° C.

Thanks to the invention which has just been described, it is possible of have a bituminous mix which may be provided at production temperatures low enough to suppress substantially totally the emissions of fumes. At these temperatures, the emissions of fumes are reduced of the order of a factor 10 with respect to the state-of-the-art coatings, while preserving the mechanical properties of the bituminous mixes obtained.

These coatings are produced and transported with lower energy consumption.

Moreover, taking the low preparation temperatures into account, the material used for the mixture of the binder and of the charges exhibits a reduced wear and the implementation of the bituminous mixes according to the invention is far more comfortable than for the state-of-the-art coatings.

1. A bituminous mix, of the type including:
mineral aggregates containing fines, sand, and optionally chippings; and
a binder based on a base product, formed of natural bitumen or of pure or modified oil industry bitumen;
characterised in that the binder includes, additionally to said base product, a first additive consisting of a hydrocarbon wax which is substantially insoluble at room temperatures in the base bitumen of the binder and whereof the melting point, measured in accordance with the ASTM and D3418 standards, is greater than 85° C., and which lowers the production temperature of the bituminous mix relative to that of the base product, in that the binder includes moreover a second additive formed of a fatty acid ester wax, said wax being of synthetic, plant or fossil plant origin and having a melting point, measured in accordance with said standards, lower than 85° C., and in that the penetration of the base product, measured in accordance with the ASTM D1321 standard, is greater than 70 tenths mm and lower than or equal to 220 tenths mm.

2. A bituminous mix according to claim 1, characterised in that the penetration of the base product, measured in accordance with the ASTM D1321 standard, is greater than 70 tenths mm and lower than or equal to 100 tenths mm.

3. A bituminous mix according to claim 1, characterised in that the acid index of said fatty acid ester ranges between 10 mg KOH/g and 70 mg KOH/g, in particular ranging between 20 mg KOH/g and 40 mg KOH/g.

4. A bituminous mix according to claim 3, characterised in that said acid index is substantially 28 mg KOH/g.

5. A bituminous mix according to claim 1, characterised in that the molecular weight of said fatty acid ester ranges between 500 g/mol and 3 000 g/mol, in particular ranging between 600 g/mol and 1 000 g/mol.

6. A bituminous mix according to claim 5, characterised in that said molecular weight is substantially 816 g/mol.

7. A bituminous mix according to claim 1, characterised in that the melting point of the hydrocarbon wax ranges between approx. 110° C. and approx. 140° C.

8. A bituminous mix according to claim 1, characterised in that said hydrocarbon wax is a polymethylene or polyolefine wax, in particular polyethylene, polypropylene or ethylene-propylene copolymer wax.

9. A bituminous mix according to claim 1, characterised in that said hydrocarbon wax has a penetration measured at 25° C. according to the ASTM D1321 standard lower than 15 tenths mm.

10. A bituminous mix according to claim 1, characterised in that the binder contains of the order of 2% to 15% in mass of the assembly formed by the first and second additives with respect to the total mass of the binder.

11. A bituminous mix according to claim 10, characterised in that the binder contains of the order of 0.5% to 10% in mass of the second additive with respect to the total mass of the binder.

12. A bituminous mix according to claim 1, characterised in that the binder contains moreover an elastomer, in particular a styrene-butadiene-styrene copolymer, a styrene-butadiene copolymer or a styrene-isoprene-styrene copolymer.

13. A bituminous mix according to claim 1, characterised in that the fatty acid ester is formed by a linear chain carboxylic monoacid ester.

14. A bituminous mix according to claim 1, characterised in that it includes manufacture-recycled coating aggregates.

15. A preparation method of a bituminous mix according to claim 1, including the following steps:
(a) the binder is mixed with the mineral aggregates,
(b) the mixture obtained from step (a) is spread,
(C)the mixture spread is compacted, and
(d)the mixture compacted is left to cool,
characterised in that the steps (a), (b) and (c) are performed at a temperature ranging between 80° C. and 130° C.

16. A use of an bituminous mix according to claim 1 as a coating for carriageway and traffic routes and their appurtenances in road, airport and city areas.

17. A bituminous mix according to claim 2, characterised in that the acid index of said fatty acid ester ranges between 10 mg KOH/g and 70 mg KOH/g, in particular ranging between 20 mg KOH/g and 40 mg KOH/g.

18. A bituminous mix according to claim 2, characterised in that the molecular weight of said fatty acid ester ranges between 500 g/mol and 3 000 g/mol, in particular ranging between 600 g/mol and 1 000 g/mol.

19. A bituminous mix according to claim 3, characterised in that the molecular weight of said fatty acid ester ranges between 500 g/mol and 3 000 g/mol, in particular ranging between 600 g/mol and 1 000 g/mol.

20. A bituminous mix according to claim 4, characterised in that the molecular weight of said fatty acid ester ranges between 500 g/mol and 3 000 g/mol, in particular ranging between 600 g/mol and 1 000 g/mol.
